(19) United States
(12) Patent Application Publication
(10) Pub. No.: US 2019/0322168 A1
(43) Pub. Date: Oct. 24, 2019

(54) Molded Vehicle Component With Integral Heat Shield and Method of Making the Same

(71) Applicant: Intellectual Property Holdings, LLC, Cleveland, OH (US)

(72) Inventors: Dan T. Moore, Cleveland Heights, OH (US); Ryan G. Sarkisian, Lakewood, OH (US); Tongzhai Gao, Euclid, OH (US); Windsor Ford, Cleveland Heights, OH (US)

(21) Appl. No.: 16/393,332

(22) Filed: Apr. 24, 2019

Related U.S. Application Data
(60) Provisional application No. 62/661,755, filed on Apr. 24, 2018.

(51) Int. Cl. B60K 15/03; B29C 49/20

(52) U.S. Cl. CPC B60K 15/03177; B29K 2023/065; B29C 2049/2021; B29C 49/20

(57) ABSTRACT

An exemplary fuel tank includes a plastic container and an integral composite heat shield. The plastic container has an outer layer formed from high-density polyethylene. The heat shield has a heat reflective layer, an attachment layer, and a non-woven insulation layer having a bonding portion that includes bi-component fibers. The outer layer of the plastic container permeates and bonds to at least a portion of bonding portion of the non-woven insulation layer.

### CROSS-REFERENCE TO RELATED APPLICATIONS

This application claims the benefit of U.S. Provisional Patent Application No. 62/661,755, filed Apr. 24, 2018, and entitled FUEL TANK WITH INTEGRAL HEAT SHIELD AND METHOD OF MAKING THE SAME (Attorney Docket 15299/04107), the entire disclosure of which is hereby incorporated herein by reference in its entirety.

### TECHNICAL FIELD

The present application relates generally to a heat shield for a vehicle component, and more particularly to a fuel tank heat shield that is integrally molded into a molded plastic fuel tank.

### BACKGROUND

Thermal control is an integral part of any automotive vehicle. Specifically, a vehicle that has the standard internal combustion engine with a catalytic converter and an exhaust system running the length of the vehicle. These systems are known to reach extreme temperatures, exceeding the melting temperatures of polymer-based components and temperature sensitive electronics in the near vicinity. Having this extremely hot system run through, next to, or beneath the gas tank requires extremely careful thermal monitoring, and in almost every case an insertion of a thermal or heat shield. Various thicknesses and alloys of aluminum and multi-layered composite materials have been used as heat shields to provide thermal protection for fuel tanks, electoral components, or other heat sensitive components of the vehicle.

Producing such heat shields are labor intensive to manufacture, requiring many steps before the heat shield is ready for assembly to the fuel tank or other portion of the vehicle. Manufacturing multiple layer shields is even more complex than single layer shields, requiring baking or forming together multiple raw materials, cutting to shape, and stamping to form a desired geometry. After forming the shield, further labor is required to attach the heat shield to the vehicle with pins, screws, and/or pressure sensitive adhesives.

### SUMMARY

An exemplary fuel tank includes a plastic container and an integral composite heat shield. The plastic container has an outer layer formed from high-density polyethylene. The heat shield has a heat reflective layer, an attachment layer, and a non-woven insulation layer having a bonding portion that includes bi-component fibers. The outer layer of the plastic container permeates and bonds to at least a portion of bonding portion of the non-woven insulation layer.

An exemplary method of making a fuel tank with an integral composite heat shield includes steps of: needling together a non-woven bonding layer and a non-woven insulation layer; laminating a heat reflective layer to the insulation layer with an attachment layer to form a composite heat shield; placing the composite heat shield on an interior surface of a mold such that the heat reflective layer faces the interior surface of the mold and the bonding layer faces a mold cavity of the mold; and blow molding the fuel tank from molten fuel tank material, wherein the molten fuel tank material penetrates at least a portion of the bonding layer of the composite heat shield.

An exemplary composite heat shield for a plastic fuel tank includes a non-woven insulation layer and a heat reflective layer. The non-woven insulation layer has a bonding portion that includes bi-component fibers. The heat reflective layer is bonded to the non-woven insulation layer with an adhesive.

A further understanding of the nature and advantages of the present invention are set forth in the following description and claims, particularly when considered in conjunction with the accompanying drawings in which like parts bear like reference numerals.

### BRIEF DESCRIPTION OF THE DRAWINGS

To further clarify various aspects of embodiments of the present disclosure, a more particular description of the certain embodiments will be made by reference to various aspects of the appended drawings. It is appreciated that these drawings depict only typical embodiments of the present disclosure and are therefore not to be considered limiting of the scope of the disclosure. Moreover, while the figures can be drawn to scale for some embodiments, the figures are not necessarily drawn to scale for all embodiments. Embodiments and other features and advantages of the present disclosure will be described and explained with additional specificity and detail through the use of the accompanying drawings in which:

FIG. 1 shows a cross-section view an exemplary composite heat shield prior to molding;

FIG. 2 shows a schematic diagram of a process for forming a layered heat shield according to an embodiment of the present application;

FIG. 3 shows a cutaway view of a blow molding apparatus in an open condition with a heat shield placed on the interior surface of the mold prior to molding;

FIG. 4 shows a cutaway view of the blow molding apparatus of FIG. 3 in a closed condition and the heat shield integrally molded with a fuel tank;

FIG. 5 shows a cross-section view an exemplary composite heat shield after molding the heat shield into the wall of a fuel tank;

FIG. 6 shows a cross-section view an exemplary composite heat shield prior to molding; and

FIG. 7 shows a cross-section view an exemplary composite heat shield after molding the heat shield into the wall of a fuel tank.

### DETAILED DESCRIPTION

The following description refers to the accompanying drawings, which illustrate specific embodiments of the present disclosure. Other embodiments having different structures and operation do not depart from the scope of the present disclosure.

Exemplary embodiments of the present disclosure are directed to devices and methods for forming a thermal or heat shield and for integrally molding the heat shield with a plastic fuel tank. It should be noted that various embodiments of heat shields, fuel tanks, and methods of making the same are disclosed herein, and any combination of these embodiments can be made unless specifically excluded. In other words, individual components of the disclosed devices and systems can be combined unless mutually exclusive or otherwise physically impossible.

As described herein, when one or more components are described as being connected, joined, affixed, coupled, attached, or otherwise interconnected, such interconnection may be direct as between the components or may be indirect such as through the use of one or more intermediary components. Also as described herein, reference to a “member,” “component,” or “portion” shall not be limited to a single structural member, component, or element but can include an assembly of components, members, or elements. Also as described herein, the terms “substantially” and “about” are defined as at least close to (and includes) a given value or state (preferably within 10% of, more preferably within 1% of, and most preferably within 0.1% of).

Molded plastic components, such as fuel tanks, are used in vehicles to reduce weight and cost. Such molded components can be formed into a variety of simple and complex shapes through techniques such blow molding. Blow molding allows for the use of multiple layers of different materials, if desired. To form component, such as a fuel tank, by blow molding, a hollow portion or parison of molten thermoformable material, such as plastic, is extruded into the interior of a closed mold having a desired shape of the fuel tank. The parison is inflated with pressurized gas until the molten thermoformable material expands and conforms to the shape of the mold.

The desired properties of a molded vehicle component—e.g., strength, weight, and formability—can be achieved through the use of thermoset and/or thermoplastic materials. In some cases, the exterior material of the molded plastic component, such as a fuel tank, is high-density polyethylene (HDPE), which has a melting point in the range of about 300 degrees to about 350 degrees Fahrenheit, depending on the structure and molecular weight of the particular HDPE material used. Providing a heat shield on the vehicle component protects the molded plastic from the heat of car components that can be significantly hotter than the melting point of the molded material, like HDPE described above, and arranged around one half of an inch or less from the molded plastic component.

Exemplary fuel tank heat shields for molded fuel tanks disclosed herein provide similar or superior performance with respect to prior art heat shields while also decreasing the labor required to assemble the heat shields to a fuel tank. These benefits are achieved by forming a multi-layered heat shield that includes a non-woven bonding layer for bonding with the fuel tank as the fuel tank is molded so that the heat shield is integrally molded with the fuel tank. That is, once the fuel tank is formed, no further steps are required to attach the heat shield to the tank. Such heat shields can be arranged in one or more desired locations during the process used to mold the fuel tank, such as, for example, blow molding.

An exemplary multi-layered heat shield is cut and formed to a desired shape. The heat shield is then placed at a desired location on an interior surface of a mold for a blow molding device manually or with a robotic arm. When the parison is extruded and expanded by air pressure—which normally ranges from 80 to 120 pounds per square inch—the molten material presses and penetrates into the bonding layer as described above. In this process, both mechanical and chemical bonds are formed between the molten material of the fuel tank and the bonding layer of the heat shield. In particular, the molten resin of the fuel tank permeates the non-woven bonding layer of the heat shield so that the cooled resin interlocks with the fibers of the non-woven bonding layer, thereby forming a mechanical bond between the heat shield and fuel tank. Chemical bonds are formed between the molten material of the fuel tank and fibers or portions of fibers of the non-woven bonding layer that melt when contacted by the molten material of the parison.

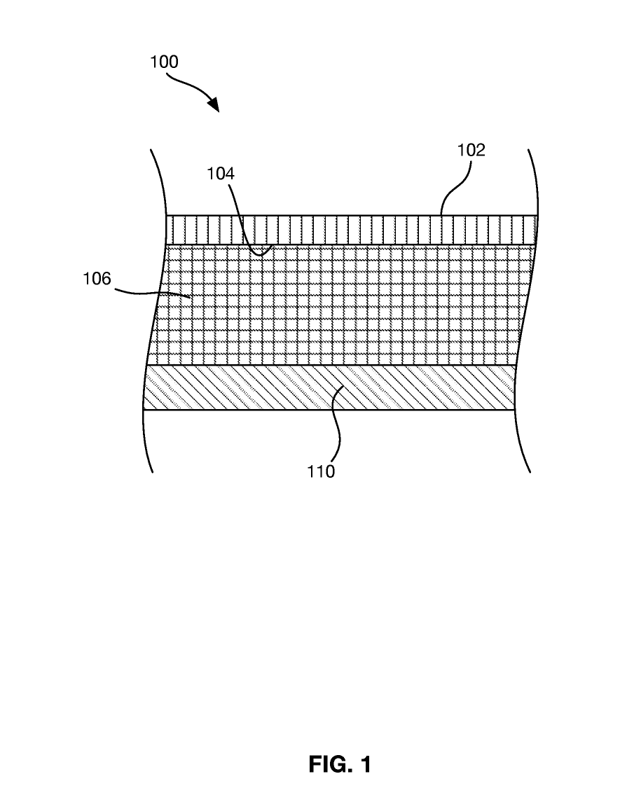

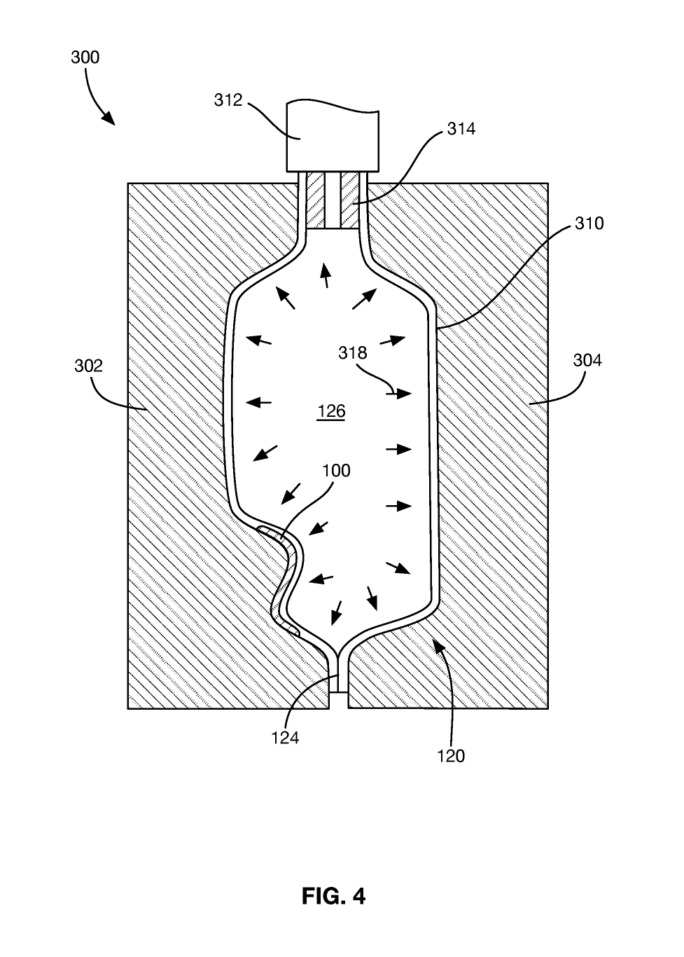

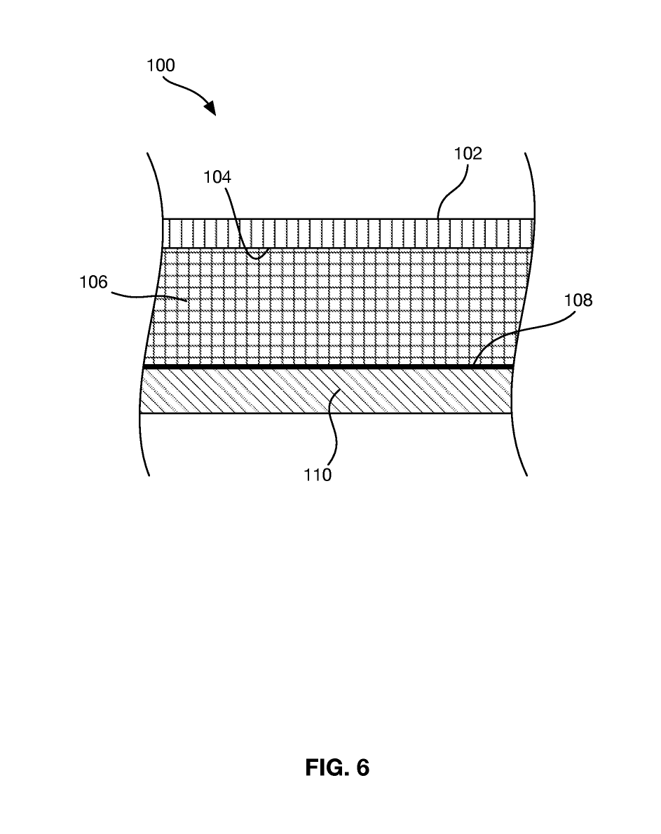

Referring now to FIG. 1, a cross-section view of an exemplary composite heat shield 100 for a molded plastic vehicle component is shown. The heat shield 100 can be molded integrally with a fuel tank 120 during molding of the fuel tank 120 (FIG. 4) and includes a heat reflective layer 102, an attachment layer 104, an insulation layer 106, and a bonding portion or layer 110. The heat shield 100 can be formed with an optional barrier layer 108 (FIG. 6). The layers 102, 104, 106, 108, 110 of the heat shield 100 are preferably made from lightweight materials, as is described in further detail below. The layers 102, 014, 106, 108, 110 can be separate layers or can be combined in a wide variety of ways so that a single piece of material performs the functions of two or more of the layers 102, 104, 106, 108, 110 described herein.

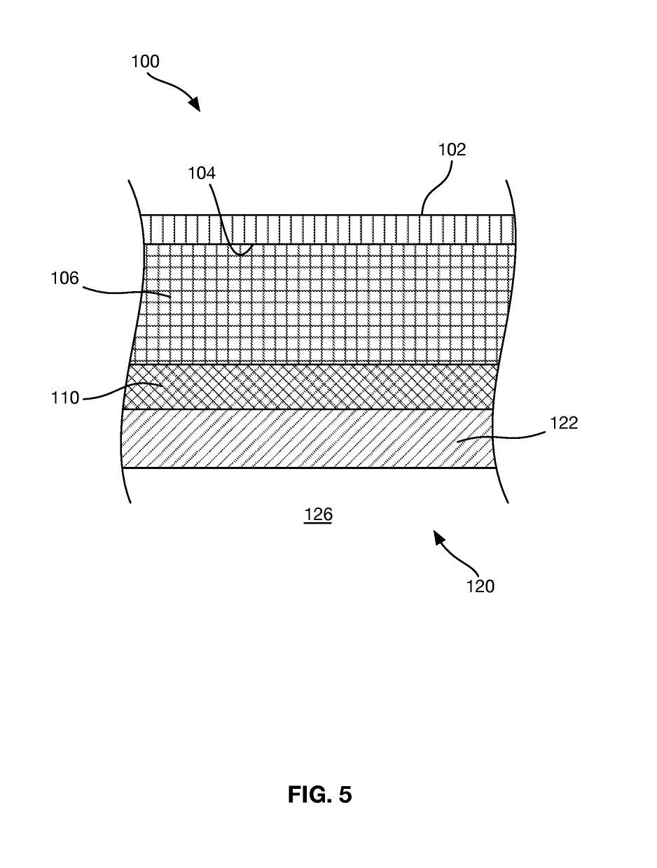

The heat reflective layer 102 reflects heat radiating from the hot components of the vehicle, such as the exhaust system. The heat reflective layer 102 is preferably resistant to corrosion so that exposure to the environment underneath the vehicle does not corrode the heat shield 100 and impair the ability of the heat shield 100 to protect the fuel tank to which the heat shield 100 is attached (e.g., FIGS. 4-5). The heat reflective layer 102 may be formed from a layer of metal film or foil, such as aluminum or stainless steel, or the like. In some embodiments, the heat reflective layer 102 may be formed from aluminum having a thickness ranging from about 0.004 inches (0.1 millimeters) to about 0.030 inches, or from about 0.010 inches to about 0.020 inches, or about 0.014 inches.

The attachment layer 104 is arranged between the heat reflective layer 102 and the insulation layer 106 to attach the heat reflective layer 102 to the insulation layer 106. The attachment layer 104 facilitates attachment of the heat reflective layer 102 to the insulation layer 106 without needing to form openings in the heat reflective layer 102 for fasteners or as a result of other mechanical attachment means, such as needling. Thus, the attachment layer 104 joins the heat reflective layer 102 to the insulation layer 106 without compromising the ability of the heat reflective layer 102 to radiate heat away from the heat shield 100.

The attachment layer 104 can be an adhesive material that adheres the heat reflective layer 102 to the insulation layer 106, such as, for example, a thermoplastic adhesive polymer web or a pressure sensitive adhesive. The attachment layer 104 can also include attachment structures (not shown), such as barbs or hooks, that protrude from and are part of the heat reflective layer 102 and interface with the insulation layer 106. The attachment structures can also be grooves or other structures that increase the surface area of the heat reflective layer 102 exposed to adhesive applied between the heat reflective layer 102 and the insulation layer 106.

The insulation layer 106 provides further thermal protection for the fuel tank and is self-extinguishing, i.e., the insulation layer 106 prohibits the spread of fires. The insulation layer 106 is formed of a material that maintains its integrity when exposed to high temperatures, e.g., exceeding 450 degrees Fahrenheit, such as a blanket of non-woven material formed from PET fibers, or other materials such as ceramic, mineral wool, glass fiber, or the like. In some embodiments, the insulation layer 106 has a thickness of about 0.098 inches to about 0.217 inches (about 2.5 millimeters to about 5.5 millimeters) and has a density of about 0.061 pounds per square foot to about 0.122 pounds per square foot (about 300 grams per square meter to about 600 grams per square meter), or about 0.081 pounds per square foot (about 400 grams per square meter).

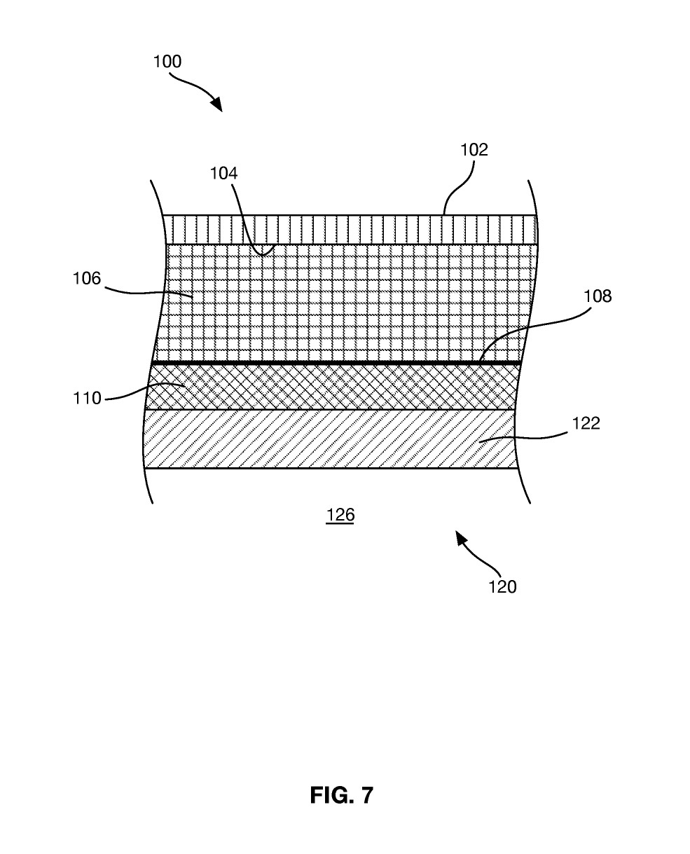

The optional barrier layer 108 (FIGS. 6-7) prohibits the migration or penetration of the molten material of the fuel tank beyond the bonding layer 110. The barrier layer 108 can be formed from a material that maintains its integrity when exposed to the temperature of the molten fuel tank material formed during molding of the fuel tank, such as about 300 degrees Fahrenheit to about 350 degrees Fahrenheit. The barrier layer 108 provides additional thermal resistance and can also provide support for the other layers 102, 104, 106, 110 of the heat shield 100 during manufacturing. In certain embodiments, the barrier layer 108 is formed of aluminum and is about 0.002 inches to about 0.005 inches thick (about 0.05 millimeters to about 0.013 millimeters).

The bonding portion or layer 110 secures the heat shield 100 to the fuel tank 120 (FIGS. 4 and 5). The bonding layer 110 is formed of a blanket of non-woven porous material so that the molten plastic material of the fuel tank infiltrates and penetrates into the bonding layer 110 during molding of the fuel tank, thereby forming a mechanical bond between a fuel tank wall 122 (FIGS. 4 and 5) and the heat shield 100. In some embodiments, the bonding layer 110 has a thickness of about 0.039 inch to about 0.128 inch (about 1 millimeter to about 3 millimeters) and has a density of about 0.020 pounds per square foot to about 0.061 pounds per square foot (about 100 grams per square meter to about 300 grams per square meter), or about 0.041 pounds per square foot (about 400 grams per square meter). As noted above, the bonding layer 110 can be a bonding portion that is formed as part of the insulation layer 106 so that a single layer of material insulates from heat and bonds to the heat fuel tank. For example, the insulation layer 106 can include a relatively small amount of bi-component fibers to facilitate bonding to the fuel tank.

The non-woven porous material used to form the bonding layer 110 can be a blanket of non-woven material formed of a plurality of fibers. The fibers are not woven together, but are bonded together chemically (e.g., by applying an adhesive or binder), mechanically (e.g., by entangling the fibers), thermally (e.g., by melting portions of the fibers together), or by some combination of the same. The fibers may be the same size or may be a blend of sizes.

In certain embodiments, the non-woven material of the insulation layer 106 and or the bonding layer 110 is formed of a blend of polyethylene terephthalate (PET) and polyester (PE) fibers. The PET fibers provide structural reinforcement of the mechanical bond with the fuel tank while the PE fibers chemically bond with the HDPE material of the fuel tank due to the similar surface energy of PE and HDPE. The PE fibers promote bonding with the HDPE of the fuel tank, thereby reducing the force required to bond the heat shield 100 to the fuel tank during molding and facilitating bonding between the shield and fuel tank without increasing or pulsing the pressure used to mold the tank. In certain embodiments, the non-woven material may be formed of bi-component fibers having a PET core and a PE sheath. As with the blend of PET and PE fibers discussed above, the PET core provides a mechanical bond and the PE sheath forms a chemical bond with the HDPE of the fuel tank.

The combination of mechanical and chemical bonds between the bonding layer 110 and the fuel tank wall 122 (FIGS. 5, 7) provides a strong bond between the heat shield 100 and the fuel tank 120. For example, during testing, the peel strength between the heat shield 100 and the HDPE layer of a fuel tank has been measured at about 15 to about 16 pounds per square inch.

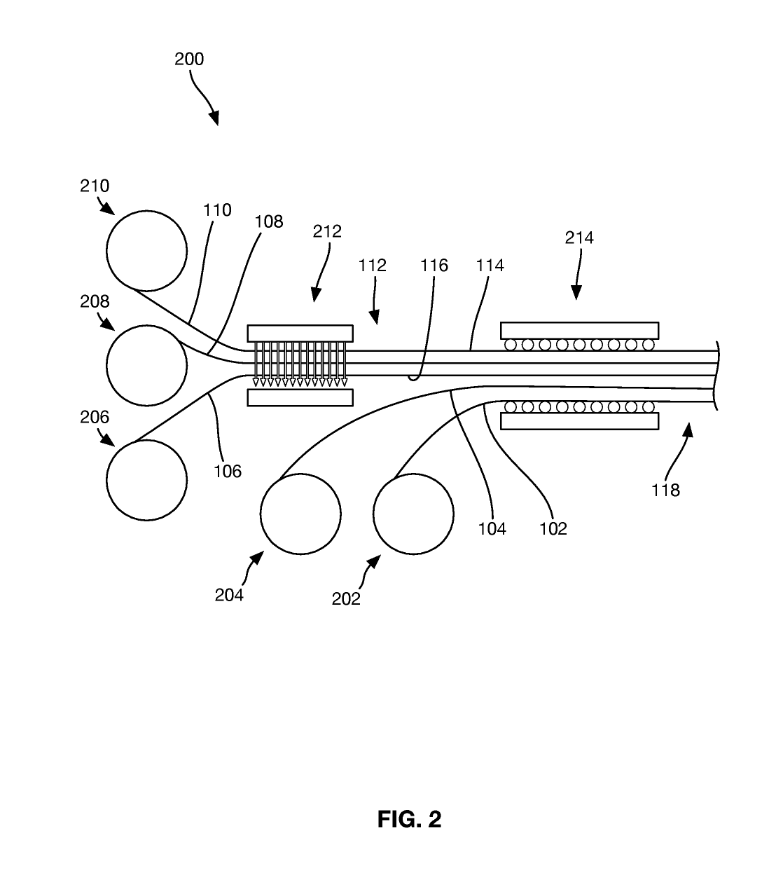

Referring now to FIG. 2, a manufacturing system 200 for the composite heat shield 100 of FIG. 1 is shown. The insulation layer 106, optional barrier layer 108, and bonding layer 110 are provided from supplies of material 206, 208, 210, respectively. These three layers 106, 108, 110 are fed from the supplies 206, 208, 210 through a needling loom 212 where they are needled together to form a needled composite 112 formed by mechanically bonding or joining the three layers 106, 108, 110. The needled composite 112 having a bonding side 114 and an insulation side 116. In embodiments including an optional barrier layer 108, the needled composite 112 can include one or more optional adhesive layers to facilitate the lamination of the barrier layer 108 to one or both of the insulation layer 106 and the bonding layer 110.

The attachment layer 104 and the heat reflective layer 102 are provided from supplies of material 204, 202, respectively. The attachment layer 104 is arranged between the insulation side 116 of the needled composite 112 and the heat reflective layer 102. The needled composite 112, attachment layer 104, and heat reflective layer 102 are fed through a laminator that heats and/or compresses the needled composite 112, attachment layer 104, and heat reflective layer 102 together to form a blanket of material 118. Lamination of the heat shield layer 102 to the needled composite 112 via the attachment layer 104 enables the heat shield layer 102 to be included in the heat shield 100 without forming perforations that would result from a needling process and that may reduce the effectiveness of the heat reflective layer. Also, in certain embodiments, the heat reflective layer is too thick to needle and would potentially damage the needling loom 112. The blanket of material 118 can be cut to a desired size and shape to form the composite heat shield 100. In certain embodiments, the heat shield is cut by die cutting and shaped by stamping.

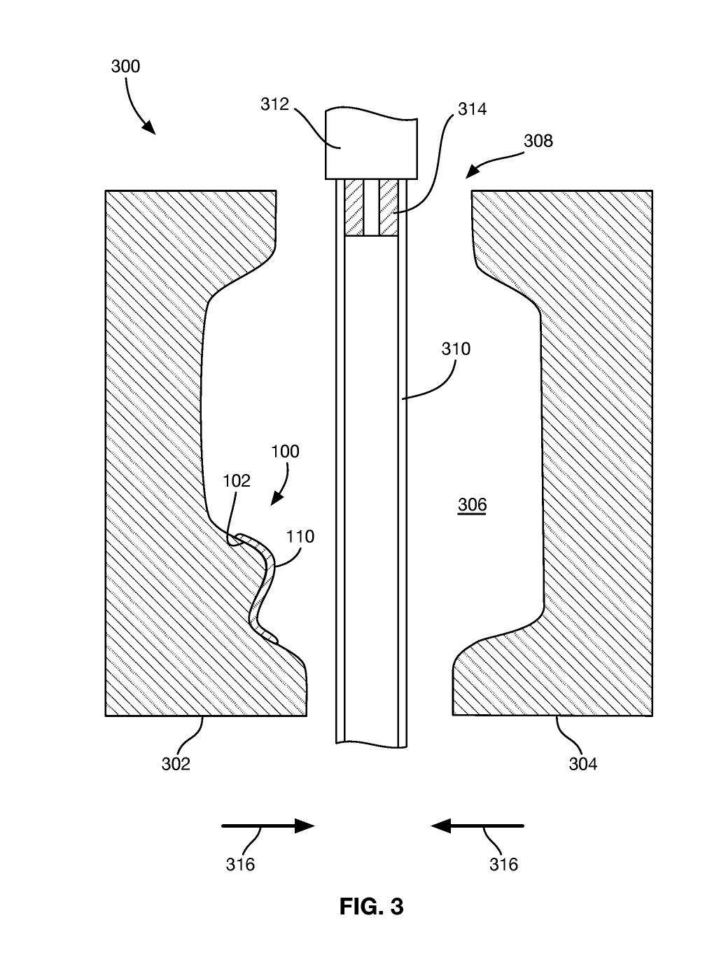

Referring now to FIGS. 3 and 4, a blow molding device 300 for forming the fuel tank 120 with an integrated composite heat shield, such as the heat shield 100 of FIG. 1, is shown. The molding device 300 includes at least two mold portions 302, 304 that encompass a mold cavity 306. An opening 308 between the mold portions 302, 304 is configured to receive a parison 310 of molten thermoformable material from an extruder 312. The parison 310 surrounds an extrusion mandrel 314 that enables pressurization of the interior of the parison 310 during the molding process.

To form the fuel tank 120, the composite heat shield 100 is cut and formed into a desired shape and placed in a desired location on one of the mold portions 302, 304. In certain embodiments, multiple heat shields are placed in different locations on one or more of the mold portions 302, 034 to protect the final fuel tank from heat in multiple locations. The heat shield 100 is oriented in so that the bonding layer 110 faces toward the mold cavity 306 and the heat reflective layer 102 faces the interior surface of the mold portion 302, 304.

As can be seen in FIG. 3, after the heat shield 100 is positioned in the mold cavity 306, the extruder 312 extrudes the parison 310 of molten thermoformable material into the mold cavity 306. The mold portions 302, 304 are moved in closing directions 316 to enclose the mold cavity 306 and to form seals around the top and bottom ends of the parison 310, as shown in FIG. 4. A bottom end of the parison 310 is sealed by pinching the material together or by inserting a plug or other sealing device (not shown) within the opening of the parison to form a sealed end 124 of the fuel tank 120.

Referring again to FIG. 4, the sealed parison 310 is inflated with pressurized gas supplied through the blow molding mandrel 314. The pressurized gas applies an inflating force 318 that expands the parison 310 and presses the molten thermoformable material of the parison 310 against the mold portions 302, 304, and against the bonding layer 110 of the heat shield 100. Pressurized gas, such as air, is supplied at a pressure ranging from about 80 pounds per square inch to about 120 pounds per square inch, or at about 90 pounds per square inch.

During the molding step, the blow molding device 300 maintains the pressure within the parison 310 for about 40 to about 80 seconds, or for about 60 seconds while the temperature of the molten plastic at about 380 degrees Fahrenheit to about 420 degrees Fahrenheit, or about 400 degrees Fahrenheit. As the fuel tank 120 is molded, the molten thermoformable material permeates the bonding layer 110 to form a bond with the heat shield 100. When the molten thermoformable material cools, the fuel tank 120 is formed with one or more heat shields 100 integrally formed into the fuel tank wall 122.

Referring now to FIG. 5, the composite heat shield 100 of FIG. 1 is shown after molding into the fuel tank 120, as described above and shown in FIGS. 3 and 4. During molding, the molten material of the fuel tank wall 122 penetrates the bonding layer 110 of the composite heat shield 100 until the molten material saturates the bonding layer 110. In embodiments including an optional barrier layer 108, the molten material of the fuel tank wall 122 is prohibited from infiltrating the heat shield 100 beyond the bonding layer 110 by the barrier layer 108, as can be seen in FIG. 7. As described above, when the material of the thermoformed fuel tank 120 cools, the one or more heat shields 100 are integrally formed into the fuel tank wall 122 and are secured thereto by mechanical and chemical bonds.

The fuel tank wall 122 has a thickness of about 0.1 inches to about 0.2 inches (about 2.5 millimeters to about 5.1 millimeters). In some embodiments, an outer HDPE layer of the fuel tank wall 122 has a thickness of about 0.01 inches to about 0.02 inches (about 0.25 millimeters to about 0.5 millimeters). The fuel tank wall 122 or outer HDPE layer can thinner than the bonding layer 110, the same thickness as the bonding layer 110, or thicker than the bonding layer 110, as is shown in FIGS. 5 and 7. The material of the fuel tank wall 122 can fully penetrate the bonding layer 110 or can partially penetrate the bonding layer 110, as long as the penetration is sufficient to attach the shield 100 to the fuel tank 120.

A particular advantage of the composite heat shield 100 of the present disclosure is that the heat shield can be easily shaped to accommodate a variety of thermal shielding applications and can be incorporated in existing blow molding operations without much effort. That is, existing molds for blow molded vehicle components, such as fuel tanks, may require some modification to accommodate the heat shield, depending on the particular parameters and shape of the component and heat shield.

While various inventive aspects, concepts and features of the disclosures may be described and illustrated herein as embodied in combination in the exemplary embodiments, these various aspects, concepts, and features may be used in many alternative embodiments, either individually or in various combinations and sub-combinations thereof. Unless expressly excluded herein all such combinations and sub-combinations are intended to be within the scope of the present application. Still further, while various alternative embodiments as to the various aspects, concepts, and features of the disclosures—such as alternative materials, structures, configurations, methods, devices, and components, alternatives as to form, fit, and function, and so on—may be described herein, such descriptions are not intended to be a complete or exhaustive list of available alternative embodiments, whether presently known or later developed. Those skilled in the art may readily adopt one or more of the inventive aspects, concepts, or features into additional embodiments and uses within the scope of the present application even if such embodiments are not expressly disclosed herein.

Additionally, even though some features, concepts, or aspects of the disclosures may be described herein as being a preferred arrangement or method, such description is not intended to suggest that such feature is required or necessary unless expressly so stated. Still further, exemplary or representative values and ranges may be included to assist in understanding the present application, however, such values and ranges are not to be construed in a limiting sense and are intended to be critical values or ranges only if so expressly stated.

Moreover, while various aspects, features and concepts may be expressly identified herein as being inventive or forming part of a disclosure, such identification is not intended to be exclusive, but rather there may be inventive aspects, concepts, and features that are fully described herein without being expressly identified as such or as part of a specific disclosure, the disclosures instead being set forth in the appended claims. Descriptions of exemplary methods or processes are not limited to inclusion of all steps as being required in all cases, nor is the order that the steps are presented to be construed as required or necessary unless expressly so stated. The words used in the claims have their full ordinary meanings and are not limited in any way by the description of the embodiments in the specification.

What is claimed is:

1. A fuel tank comprising:
a plastic container having an outer layer formed from high-density polyethylene;
an integral heat shield comprising:
a non-woven insulation layer having a bonding portion comprising bi-component fibers;
a heat reflective layer; and
an attachment layer for attaching the heat reflective layer to the non-woven insulation layer;
wherein the outer layer of the plastic container permeates and bonds to at least a portion of bonding portion of the non-woven insulation layer.

2. The fuel tank of claim 1, wherein the bonding portion is a non-woven bonding layer attached to the non-woven insulation layer.

3. The fuel tank of claim 2, further comprising a barrier layer arranged between the non-woven insulation layer and the non-woven bonding layer.

4. The fuel tank of claim 2, wherein the non-woven bonding layer is needled to the non-woven insulation layer.

5. The fuel tank of claim 1, wherein the attachment layer is an adhesive layer.

6. The fuel tank of claim 1, wherein the bonding portion comprises at least one of polyethylene terephthalate fibers and polyester fibers.

7. The fuel tank of claim 1, wherein a material of a sheath of the bi-component fibers is different from a material of the outer layer of the plastic container.

8. The fuel tank of claim 1, wherein the insulation layer has a density of about 0.061 pounds per square foot to about 0.122 pounds per square foot.

9. The fuel tank of claim 1, wherein the bonding portion has a density of about 0.020 pounds per square foot to about 0.061 pounds per square foot.

10. The fuel tank of claim 1, wherein the outer wall of the plastic container penetrates at least 0.1 inches into the bonding portion.

11. A method of making a fuel tank with an integral composite heat shield, the method comprising:
needling together a non-woven bonding layer and a non-woven insulation layer;
laminating a heat reflective layer to the insulation layer with an attachment layer to form a composite heat shield;
placing the composite heat shield on an interior surface of a mold such that the heat reflective layer faces the interior surface of the mold and the bonding layer faces a mold cavity of the mold; and
blow molding the fuel tank from molten fuel tank material, wherein the molten fuel tank material penetrates at least a portion of the bonding layer of the composite heat shield.

12. The method of claim 11, wherein the step of needling further comprises needling a barrier layer between the non-woven bonding layer and the non-woven insulation layer.

13. The method of claim 11, wherein the molten fuel tank material penetrates at least 0.1 inches into the non-woven bonding layer.

14. The method of claim 11, wherein the non-woven bonding layer comprises at least one of polyethylene terephthalate fibers and polyester fibers.

15. The fuel tank of claim 11, wherein the non-woven bonding layer comprises bi-component fibers and a material of a sheath of the bi-component fibers is different from a material of the outer layer of the molded plastic container.

16. A heat shield for a plastic fuel tank, the heat shield comprising:
a non-woven insulation layer having a bonding portion comprising bicomponent fibers; and
a heat reflective layer bonded to the non-woven insulation layer with an adhesive.

17. The heat shield of claim 16, wherein the bonding portion is a non-woven bonding layer needled to the non-woven insulation layer.

18. The fuel tank of claim 17, further comprising a barrier layer arranged between the non-woven insulation layer and the non-woven bonding layer.

19. The fuel tank of claim 17, wherein the non-woven bonding layer is needled to the non-woven insulation layer.

20. The heat shield of claim 16, wherein the bonding portion comprises at least one of polyethylene terephthalate fibers and polyester fibers.
